(19) United States
(12) Patent Application Publication
(10) Pub. No.: US 2004/0003416 A1
(43) Pub. Date: Jan. 1, 2004

(54) Apparatus for controlling audio/video ouputs

(76) Inventor: Jung Ho Park, Seoul (KR)

Correspondence Address: David A. Einhorn, Esq., Anderson Kill & Olick, P.C., 1251 Avenue of the Americas, New York, NY, 10020, US

(21) Appl. No.: 10/600,635

(22) Filed: Jun. 19, 2003

(30) Foreign Application Priority Data
Jun. 28, 2002 (KR) 10-2002-36608

(51) Int. Cl. H04N 7/16

(52) U.S. Cl. 725/153; 725/141

(57) ABSTRACT

An apparatus for controlling A/V outputs of a plurality of A/V players includes a selection input unit for receiving target data that represents a target A/V display unit among a plurality of A/V display units and selection data which is used to select an A/V player from the plurality of A/V players for the target A/V display unit to thereby generate a selection signal corresponding to the selected A/V player and the target A/V display unit and a control unit receiving the selection signal to control the selected A/V player so that an output of the selected A/V player is displayed on the target A/V display unit.

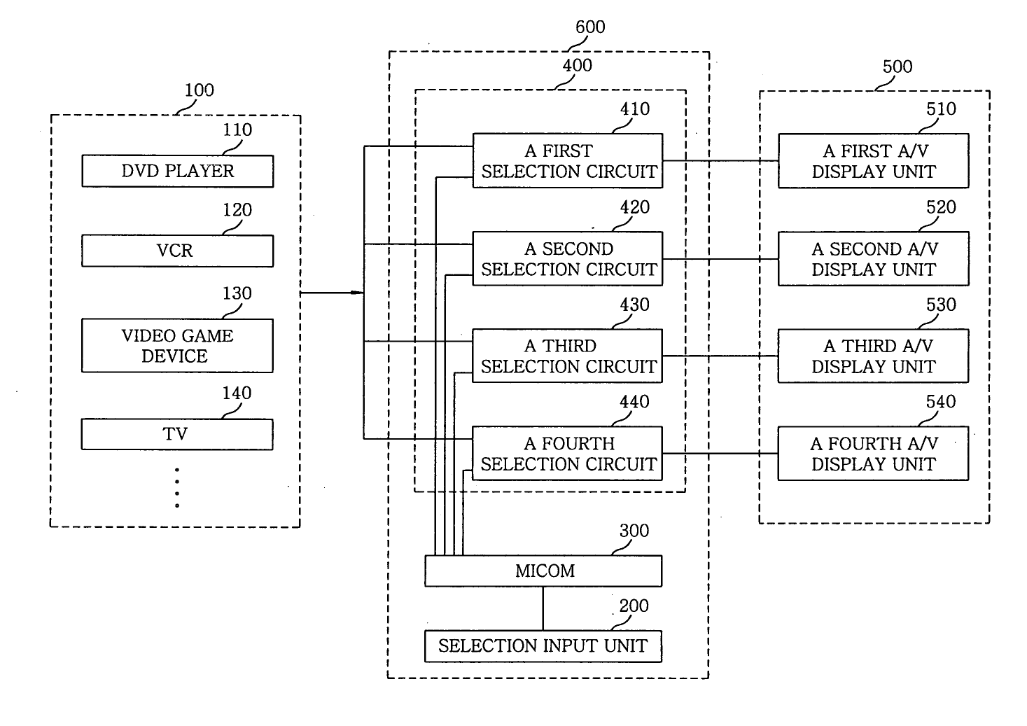

### FIELD OF THE INVENTION

The present invention relates to an apparatus for controlling audio/video (A/V) outputs of a plurality of A/V players; and, more particularly, to an apparatus for controlling a plurality of A/V outputs of a plurality of A/V players so that an A/V display unit among a plurality of A/V display units can select an A/V player among the plurality of A/V players as an A/V output source.

### BACKGROUND OF THE INVENTION

Generally, an A/V player, e.g., a TV, a VCR, a camcorder, a CD player, a DVD player or a video game device, generates an A/V signal to display an output, such as an image, a sound or a combination thereof, on an A/V display unit, e.g., a monitor, a speaker or a combination thereof. On occasion, an A/V player can be connected to a plurality of A/V display units to thereby display an output on the plurality of A/V display units. This conventional scheme, providing a plurality of users with an A/V display service, can be employed in, e.g., a car, a bus or a classroom.

However, in this scheme, the A/V output displayed on each user's A/V display unit can only be originated from the same A/V player that is connected to each user's A/V display unit. Therefore, even when a plurality of A/V players is available, it is difficult for each user to arbitrarily select one of the A/V players as an A/V output source. For example, in a car equipped with a TV, a VCR and a DVD player, every passenger can only use the same A/V player, unless a passenger is provided with more than one A/V display units. Accordingly, in such a case, once the VCR is selected as an A/V output source, none of the passengers can use the TV or the DVD player.

### SUMMARY OF THE INVENTION

It is, therefore, an object of the present invention to provide an apparatus for controlling A/V outputs of a plurality of A/V players so that an A/V display unit among a plurality of A/V display units can select an A/V player among a plurality of A/V players as an A/V output source.

In accordance with a preferred embodiment of the present invention, there is provided an apparatus for controlling A/V outputs of a plurality of A/V players, the apparatus including: a selection input unit for receiving a target data that represents a target A/V display unit among a plurality of A/V display units and selection data that is used to select an A/V player among the plurality of A/V players for the target A/V display unit to generate a selection signal corresponding to the selected A/V player and the target A/V display unit; and a control unit receiving the selection signal to control the selected A/V player so that an output of the selected A/V player is displayed on the target A/V display unit.

In accordance with another preferred embodiment of the present invention, there is provided an apparatus for controlling A/V outputs of a plurality of A/V players, the apparatus including: a selection input unit having a plurality of selection input subunits, which are respectively connected to the plurality of A/V display units, wherein each selection input subunit receives a selection data for selecting an A/V player among the plurality of A/V players to thereby generate a selection signal corresponding to the selected A/V player; and a control unit for receiving the selection signal to control the selected A/V player so that an output of the selected A/V player is displayed on the target A/V display unit.

### BRIEF DESCRIPTION OF THE DRAWING

The above and other objects and features of the present invention will become apparent from the following description of preferred embodiments given in conjunction with the accompanying drawing.

The drawing represents a block diagram of an A/V system including a preferred embodiment of an A/V output control apparatus in accordance with the present invention.

### DETAILED DESCRIPTION OF PREFERRED EMBODIMENTS

Referring to the drawing, a block diagram of an A/V system is illustrated, wherein the A/V system includes an A/V player set 100, an A/V display unit set 500 and an A/V output control apparatus 600 in accordance with a preferred embodiment of the present invention.

The A/V player set 100 has a plurality of A/V players, for example, a DVD player 110, a VCR 120, a video game device 130 and a TV 140. The display unit set 500 has a plurality of, e.g., four A/V display units. The A/V display units are respectively designated as a first A/V display unit 510, a second A/V display unit 520, a third A/V display unit 530 and a fourth A/V display unit 540, each of which can be a monitor, a speaker or a combination thereof. Alternatively, a number of the A/V display units may be other than four.

The A/V output control apparatus 600 has a selection input unit 200, a micom 300 and a selection unit 400. The selection unit 400 further contains a plurality of, e.g., four, selection circuits which are respectively connected to the plurality of A/V display units and designated as a first selection circuit 410, a second selection circuit 420, a third selection circuit 430 and a fourth selection circuit 440. Alternatively, a number of the selection circuits may be other than four if only it equals to the number of the A/V display units.

The selection input unit 200 receives target data that represents a target A/V display unit on which an A/V output will be displayed and selection data for selecting an A/V player among the plurality of the A/V players for the target A/V display unit. Then, the selection input unit 200 generates a selection signal corresponding to the selected A/V player and the target A/V display unit to thereby send the selection signal to the micom 300.

Alternatively, the selection input unit 200 can contain a plurality of selection input subunits which are respectively connected to the plurality of A/V display units. In this case, a selection input subunit connected to the target A/V display unit receives a selection data for selecting an A/V player among the plurality of the A/V players. Then, the selection input subunit connected to the target A/V display unit generates a selection signal corresponding to the selected A/V player to thereby send the selection signal to the micom 300.

The micom 300 receives the selection signal and generates a control signal corresponding to the selected A/V player that is sent to a selection circuit connected to the target A/V display unit. The selection circuit having received the control signal sets the selected A/V player as an A/V output source of the target A/V display unit, so that an A/V output, i.e., an image, a sound or a combination thereof, of the selected A/V player is displayed on the target A/V display unit.

Hereinafter, the preferred embodiment of the present invention will be described in more detail.

When a first user using the first A/V display unit 510 wants to select, e.g., TV 140 as an A/V output source, he inputs target data that represents the first A/V display unit 510 and selection data for selecting, e.g., TV into the selection input unit 200. Then, the selection input unit 200 generates a selection signal corresponding to, e.g., the TV and the first A/V display unit 510 to send it to the micom 300. The micom 300 generates a control signal corresponding to, e.g., the TV that is sent to the selection circuit connected to the first A/V display unit 510, i.e., the first selection circuit 410. The first selection circuit 410 sets, e.g., the TV as an A/V output source of the first A/V display unit 510, so that an A/V output of, e.g., the TV is displayed on the first A/V display unit 510.

Similarly, when a second user using the second A/V display unit 520 wants to select, e.g., VCR 120 as an A/V output source, he inputs a target data corresponding to the second A/V display unit 520 and selection data corresponding to, e.g., the VCR into the selection input unit 200. Then, the selection input unit 200 generates a selection signal corresponding to, e.g., the VCR and the second A/V display unit 520, which is then sent to the micom 300. The micom 300 generates a control signal corresponding to, e.g., the VCR to send it to the second selection circuit 420. The second selection circuit 420 sets, e.g., the VCR as an A/V output source of the second A/V display unit 520, so that an A/V output of, e.g., the VCR is displayed on the second A/V display unit 520. In the same manner, a third user using the third A/V display unit 530 can select an A/V player as an A/V output source that he wants. So can a fourth user using the fourth A/V display unit 540.

Alternatively, the selection input unit 200 may contain a plurality of selection input subunits, each of which is connected to each of the plurality of A/V display units. In this case, when a first user using the first A/V display unit 510 wants to select, e.g., TV 140 as an A/V output source, he inputs selection data corresponding to, e.g., the TV into the selection input unit 200. Then, the selection input subunit connected to the target A/V display unit generates a selection signal corresponding to, e.g., the TV to thereby send it to the micom 300. In the same manner, a second user using the second A/V display unit 520 can select an A/V player as an A/V output source that he wants and so can a third user using the third A/V display unit 530 and a fourth user using the fourth A/V display unit 540.

While the invention has been shown and described with respect to the preferred embodiments, it will be understood by those skilled in the art that various changes and modifications may be made without departing from the spirit and scope of the invention as defined in the following claims. For example, one or more IC chips may be provided as a control unit in place of both the micom 300 and the selection unit 400, if the chip or chips can receive the selection signal and control an A/V output of the selected A/V player to be displayed on the target A/V display unit.

What is claimed is:

1. An apparatus for controlling A/V outputs of a plurality of A/V players, the apparatus comprising:
a selection input unit for receiving target data that represents a target A/V display unit among a plurality of A/V display units and selection data which is used to select an A/V player among the plurality of A/V players for the target A/V display unit to generate a selection signal corresponding to the selected A/V player and the target A/V display unit; and
a control unit for receiving the selection signal to control the selected A/V player so that an output of the selected A/V player is displayed on the target A/V display unit.

2. The apparatus of claim 1, wherein the control unit further includes:
a micom for receiving the selection signal to generate a control signal corresponding to the selected A/V player; and
a selection unit having a plurality of selection circuits which are respectively connected to the plurality of A/V display units, wherein a selection circuit among the plurality of selection circuits is connected to the target A/V display unit and receives the control signal to control the selected A/V player so that an output of the selected A/V player is displayed on the target A/V display unit.

3. The apparatus of claim 1, wherein the control unit is implemented by one or more IC chips.

4. An apparatus for controlling A/V outputs of a plurality of A/V players, the apparatus comprising:
a selection input unit having a plurality of selection input subunits which are respectively connected to the plurality of A/V display units, wherein each selection input subunit receives selection data for selecting an A/V player among the plurality of A/V players to generate a selection signal corresponding to the selected A/V player; and
a control unit for receiving the selection signal to control the selected A/V player so that an output of the selected A/V player is displayed on the target A/V display unit.

5. The apparatus of claim 4, wherein the control unit further includes:
a micom for receiving the selection signal to generate a control signal corresponding to the selected A/V player; and
a selection unit having a plurality of selection circuits which are respectively connected to the plurality of A/V display units, wherein a selection circuit among the plurality of selection circuits is connected to the target A/V display unit and receives the control signal to control the selected A/V player so that an output of the selected A/V player is displayed on the target A/V display unit.

5. The apparatus of claim 4, wherein the control unit further includes:
a micom for receiving the selection signal to thereby generate a control signal corresponding to the selected A/V player; and
a selection unit having a plurality of selection circuits which are respectively connected to the plurality of A/V display units, wherein a selection circuit connected to the target A/V display unit receives the control signal to control the selected A/V player so that an output of the selected A/V player is displayed on the target A/V display unit.

6. The apparatus of claim 4, wherein the control unit is implemented by one or more IC chips.
